(19) United States
(12) Patent Application Publication
(10) Pub. No.: US 2026/0079983 A1
(43) Pub. Date: Mar. 19, 2026

(54) RETRIEVAL-AUGMENTED QUERY-AND-ANSWER METHOD AND APPARATUS, DEVICE, AND MEDIUM

(71) Applicant: BEIJING BAIDU NETCOM SCIENCE TECHNOLOGY CO., LTD., Beijing (CN)

(72) Inventors: Yiling Wu, Beijing (CN); Junchao Zhang, Beijing (CN); Lei Shi, Beijing (CN)

(73) Assignee: BEIJING BAIDU NETCOM SCIENCE TECHNOLOGY CO., LTD., Beijing (CN)

(21) Appl. No.: 19/304,368

(22) Filed: Aug. 19, 2025

(30) Foreign Application Priority Data
Sep. 19, 2024 (CN) 202411312623.2

(51) Int. Cl. G06F 16/334; G06F 40/263; G06F 40/30; G06F 40/58

(52) U.S. Cl. CPC G06F 16/3347; G06F 40/263; G06F 40/30; G06F 40/58

(57) ABSTRACT

A retrieval-augmented query-and-answer method includes acquiring a to-be-answered query; performing character-level matching and screening between the to-be-answered query and offline-stored material knowledge points in a database to obtain preliminarily screened material knowledge points; performing semantic-level matching and screening between the to-be-answered query and the preliminarily screened material knowledge points to obtain a finely screened material knowledge point; acquiring a bound material slice from the database based on the finely screened material knowledge point; generating prompt information based on the bound material slice and the to-be-answered query; and inputting the prompt information into a query-and-answer large model, processing the prompt information, and generating an answer. This solution can accelerate the query-and-answer processing speed based on a large model and improve the accuracy of crosslingual document retrieval.

### CROSS-REFERENCE TO RELATED APPLICATION(S)

This application claims priority to Chinese Patent Application No. CN202411312623.2 filed Sep. 19, 2024, the disclosure of which is incorporated herein by reference in its entirety.

### TECHNICAL FIELD

The present disclosure relates to the field of computer technologies, particularly artificial intelligence, intelligent retrieval, and large model technologies.

### BACKGROUND

In a query-and-answer scenario where a large model is used to generate an answer to a query from a user, it is often necessary to retrieve document materials associated with the query which is then input into the large model to generate the answer to the query. Since the scope of the document materials is quite broad, it is inevitable that documents in different languages are involved.

In the process of crosslingual document retrieval, document inputting into a large model, and answer generation, the presence of documents in different languages leads to problems such as low matching accuracy and high computational load.

### SUMMARY

The present disclosure provides a retrieval-augmented query-and-answer method and apparatus, a device, and a medium.

According to an aspect of the present disclosure, a retrieval-augmented query-and-answer method is provided.

The method includes acquiring a to-be-answered query; performing character-level matching and screening between the to-be-answered query and offline-stored material knowledge points in a database to obtain preliminarily screened material knowledge points; performing semantic-level matching and screening between the to-be-answered query and the preliminarily screened material knowledge points to obtain a finely screened material knowledge point; acquiring a bound material slice from the database based on the finely screened material knowledge point; generating prompt information based on the bound material slice and the to-be-answered query; and inputting the prompt information into a query-and-answer large model, processing the prompt information, and generating an answer.

The database offline stores bound material knowledge points and bound material slices. The material slices are in at least two languages. The material knowledge points are in a standard language. The material knowledge points in the standard language are obtained from translation of material slices in a non-standard language.

According to another aspect of the present disclosure, a retrieval-augmented query-and-answer apparatus is provided. The apparatus includes a to-be-answered query acquisition module, preliminarily screened material knowledge point acquisition module, a finely screened material knowledge point acquisition module, a material slice acquisition module, a prompt information generation module, and an answer generation module.

The to-be-answered query acquisition module is configured to acquire a to-be-answered query.

The preliminarily screened material knowledge point acquisition module is configured to perform character-level matching and screening between the to-be-answered query and offline-stored material knowledge points in a database to obtain preliminarily screened material knowledge points.

The finely screened material knowledge point acquisition module is configured to perform semantic-level matching and screening between the to-be-answered query and the preliminarily screened material knowledge points to obtain a finely screened material knowledge point.

The material slice acquisition module is configured to acquire a bound material slice from the database based on the finely screened material knowledge point.

The prompt information generation module is configured to generate prompt information based on the bound material slice and the to-be-answered query.

The answer generation module is configured to input the prompt information into a query-and-answer large model, process the prompt information, and generate an answer.

The database offline stores bound material knowledge points and bound material slices. The material slices are in at least two languages. The material knowledge points are in a standard language. The material knowledge points in the standard language are obtained from translation of material slices in a non-standard language.

According to another aspect of the present disclosure, an electronic device is provided. The electronic device includes at least one processor and a memory communicatively connected to the at least one processor.

The memory stores instructions executable by the at least one processor to enable the at least one processor to perform the retrieval-augmented query-and-answer method of any embodiment of the present disclosure.

According to another aspect of the present disclosure, a non-transitory computer-readable storage medium is provided. The non-transitory computer-readable storage medium stores computer instructions for causing a computer to perform the retrieval-augmented query-and-answer method of any embodiment of the present disclosure.

According to another aspect of the present disclosure, a computer program product is provided. The computer program product includes a computer program which, when executed by a processor, causes the processor to perform the retrieval-augmented query-and-answer method of any embodiment of the present disclosure.

The technology of the present disclosure can translate and process multilingual materials during the offline stage and can standardize the language of knowledge points. This facilitates quick and accurate matching of knowledge points in the same language during online query-and-answer processing, thereby improving the accuracy of matching between the to-be-answered query and material knowledge points and reducing the computational load in the answer generation process.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1 is a flowchart of a retrieval-augmented query-and-answer method according to an embodiment of the present disclosure.

FIG. 2 is a flowchart of a retrieval-augmented query-and-answer method according to an embodiment of the present disclosure.

FIG. 3A is a flowchart of a retrieval-augmented query-and-answer method according to an embodiment of the present disclosure.

FIG. 3B is a flowchart of a retrieval-augmented query-and-answer method according to an embodiment of the present disclosure.

FIG. 3C is a flowchart of material slice processing according to an embodiment of the present disclosure.

FIG. 4 is a block diagram of a retrieval-augmented query-and-answer apparatus according to an embodiment of the present disclosure.

FIG. 5 is a block diagram of an electronic device for implementing a retrieval-augmented query-and-answer method according to an embodiment of the present disclosure.

### DETAILED DESCRIPTION

Example embodiments of the present disclosure, including details of embodiments of the present disclosure, are described hereinafter in conjunction with drawings to facilitate understanding. The example embodiments are illustrative. Therefore, it is to be appreciated by those of ordinary skill in the art that various changes and modifications may be made to the embodiments described herein without departing from the scope of the present disclosure. Similarly, description of well-known functions and constructions is omitted hereinafter for clarity and conciseness.

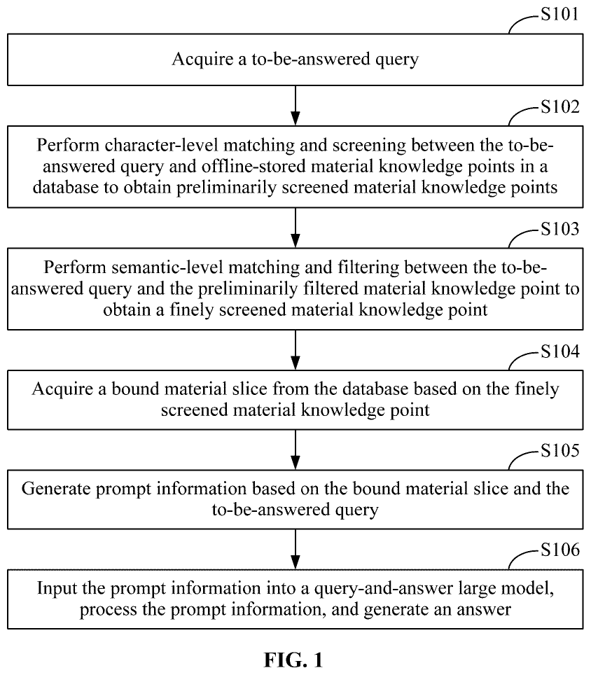

FIG. 1 is a flowchart of a retrieval-augmented query-and-answer method according to an embodiment of the present disclosure. This embodiment of the present disclosure is applicable to crosslingual query-and-answer based on a large model, that is, applicable to a query-and-answer scenario by using a retrieval-augmented generation (RAG) technology. In the related RAG technology, it is required to retrieve materials from a material base based on input information to obtain materials that match the input information. The matched materials and the input information are then input into the large model. The large model generates the desired result based on the matched materials and the input information. In a query-and-answer scenario, the input information is typically a query posed by a user, and the materials are the content that can be used in answering the query, such as various documents. For textual queries and materials, a query and matched materials are input into a large language model (LLM). The large language model performs semantic analysis on both the query and the materials and generates an answer. This method can be performed by a retrieval-augmented query-and-answer apparatus. This apparatus may be implemented by hardware and/or software and may be configured in an electronic device. Referring to FIG. 1, the method includes the following:

In S101, a to-be-answered query is acquired.

The to-be-answered query refers to a user query that requires an answer.

The to-be-answered query may be acquired through a user interaction interface.

In S102, character-level matching and screening between the to-be-answered query and offline-stored material knowledge points in a database are performed to obtain preliminarily screened material knowledge points.

The material knowledge point may be a sentence or word that represents independent semantics in the material. The material knowledge point is in a standard language. The standard language refers to a language specified for a particular query-and-answer scenario. The standard language may be determined based on the language of a large number of supported to-be-answered queries. For example, when the majority of the to-be-answered queries are in Chinese, the standard language is Chinese. Similarly, when the majority of the to-be-answered queries are in English, the standard language is English. A standard language may be set for a database. Typically, one database has one standard language. Alternatively, different databases may be assigned different standard languages to support to-be-answered queries in different languages. The preliminarily screened material knowledge points refers to a knowledge point obtained from character-level matching and screening of material knowledge points. Optionally, the preliminarily screened material knowledge points are material knowledge point in a standard language. Here the material knowledge point in the standard language may be a material knowledge point obtained from materials in a standard language and/or a material knowledge point obtained from extraction from materials in a non-standard language and translation of the extracted material knowledge point.

Character-level matching is performed between the to-be-answered query and the offline-stored material knowledge points in the database by using a preset character-level matching algorithm to obtain a character-level matching degree. A material knowledge point whose character-level matching degree is greater than the matching degree threshold is used as a preliminary screened material knowledge point. The preset character-level matching algorithm may be preconfigured according to actual service requirements. For example, the preset character-level matching algorithm may be the Knuth-Morris-Pratt (KMP) algorithm. This is not limited by this embodiment of the present disclosure. The matching degree threshold refers to a numerical value for defining the degree of matching between the to-be-answered query and the matched material knowledge point. The matching degree threshold may be determined through extensive experimentation or preconfigured based on the expertise of those skilled in the art. This is not limited by this embodiment of the present disclosure.

The character-level matching and screening between the to-be-answered query and the offline-stored material knowledge points in the database can eliminate material knowledge points entirely unrelated to the to-be-answered query. This reduces the computational load during the answer generation process, thereby improving the speed of response of the query-and-answer large model to the to-be-answered query.

In S103, semantic-level matching and screening is performed between the to-be-answered query and the preliminarily screened material knowledge points to obtain a finely screened material knowledge point.

The finely screened material knowledge point refers to a knowledge point remaining after the preliminarily screened material knowledge points undergoes semantic-level matching and screening.

Semantic matching may be performed in one or more manners. The fine screening is performed in conjunction with the semantic matching result. For example, semantic retrieval or semantic vector model matching may be performed.

In one or more embodiments, based on a multilingual semantic matching model, the to-be-answered query and the preliminarily screened material knowledge points are vectorized separately to obtain a query vector and multiple preliminarily screened knowledge point vectors. The semantic similarity between the query vector and each preliminarily screened knowledge point vector is calculated. The preliminarily screened material knowledge points corresponding to the preliminarily screened knowledge point vector whose semantic similarity is greater than the semantic similarity threshold is taken as the finely screened material knowledge point. The preliminarily screened material knowledge points correspond one-to-one with the preliminarily screened knowledge point vectors. The multilingual semantic matching model may be preconfigured according to actual service requirements. For example, the multilingual semantic matching model may be an XLM model (crosslingual pretrained model), an XLM-R model (large-scale unsupervised crosslingual representation model), or an m-BERT model (multilingual BERT). BERT refers to bidirectional encoder representations from transformers. BERT is also known as a bidirectional transformer model. BERT is a pretrained language model based on a Transformer architecture.

After character-level matching and screening is performed between the to-be-answered query and the offline-stored material knowledge points in the database to obtain the preliminarily screened material knowledge point, semantic-level matching and screening is performed between the to-be-answered query and the preliminarily screened material knowledge point. This solution takes into account the user intent behind the to-be-answered query and the semantic meaning behind the material knowledge points, resulting in a more accurate finely screened material knowledge point. Consequently, the knowledge point most relevant to the to-be-answered query can be retrieved from the database.

In S104, a bound material slice is acquired from the database based on the finely screened material knowledge point.

The database offline stores bound material knowledge points and material slices. One finely screened material knowledge point is bound to one material slice. One material slice can be bound to multiple finely screened material knowledge points.

For each finely screened material knowledge point, with the knowledge point identifier of the finely screened material knowledge point as the index, the material slice bound to the finely screened material knowledge point is retrieved from the database. Similarly, the material slice bound to each finely screened material knowledge point can be obtained.

In S105, prompt information is generated based on the bound material slice and the to-be-answered query.

The material slice and the to-be-answered query are used to generate prompt information. The prompt information can be parsed by the large model during the answer generation process. The format of the prompt information may be set according to the input format required by the large model.

In one or more embodiments, a prompt information template is acquired, the material slice is added to the material area of the prompt information template, and the to-be-answered query is added to the query area of the prompt information template, so that prompt information is obtained. The prompt information template may be preconfigured according to actual service requirements. For example, the prompt information template may be as follows:

Given the following information:
Material slice 1
Material slice 2
. . .
Material slice n

Please answer the following query:

To-be-answered query

The phrases “Given the following information” and “Please answer the following query” may serve as template statements for the prompt information template and may be used to define each content area. Certainly, different large models may require different template configurations. For example, when the material slices are in different languages, the material area may be subdivided into language-specific material areas.

It is to be understood that adding the material slice and the to-be-answered query into the corresponding areas of the prompt information template enables the rapid generation of prompt information, thereby improving the efficiency of response of the query-and-answer large model to the to-be-answered query. Additionally, since the role of the material slice in the query-and-answer large model and the role of the to-be-answered query in the query-and-answer large model have been distinguished from each other in the prompt information template, facilitating answering the query by the query-and-answer large model, thereby enhancing the accuracy of answering the query by the query-and-answer large mode.

In S106, the prompt information is input into a query-and-answer large model and processed, and an answer is generated.

In one or more embodiments, the query-and-answer large model is pretrained based on actual service requirements. The query-and-answer large model is typically a large language model determined through pretraining and service fine-tuning training.

The database offline stores bound material knowledge points and bound material slices. The material slices are in at least two languages. The material knowledge points are in a standard language. The material knowledge points in the standard language are obtained from translation of material slices in a non-standard language.

It is to be noted that some of the material knowledge points in a standard language are derived from material slices in a non-standard language through translation. The non-standard language refers to a language other than the standard language. It is also to be noted that the material slices are in at least two languages. For example, the standard language is Chinese, and the non-standard languages include English, French, Japanese, and any language other than Chinese.

In an optional embodiment, translating material slices in a non-standard language into material knowledge points in a standard language can be achieved as follows: Based on a text segmentation method, the material slices in the non-standard language are processed into one or more material knowledge points in the non-standard language. The text segmentation method may be preset according to actual service requirements. For example, the text segmentation method may be sentence-based segmentation or paragraph-based segmentation. Based on a first language recognition model, the language of the material knowledge points in the non-standard language is recognized. The specialized translator corresponding to the recognized language is used to translate the material knowledge points in the non-standard language into material knowledge points in the standard language. The first language recognition model may be obtained by being trained using sample knowledge points corresponding to the language.

It is to be understood that converting material knowledge points in the non-standard language into material knowledge points in the standard language and storing them in the database enriches the material knowledge points in the database, improves the matching success rate between the to-be-answered query and the material knowledge points in the database, and facilitates a more comprehensive retrieval of relevant material knowledge points for the to-be-answered query.

The solution of this embodiment of the present disclosure includes acquiring a to-be-answered query; performing character-level matching and screening between the to-be-answered query and offline-stored material knowledge points in a database to obtain preliminarily screened material knowledge points; performing semantic-level matching and screening between the to-be-answered query and the preliminarily screened material knowledge points to obtain a finely screened material knowledge point; acquiring a bound material slice from the database based on the finely screened material knowledge point; generating prompt information based on the bound material slice and the to-be-answered query; and inputting the prompt information into a query-and-answer large model, processing the prompt information, and generating an answer. The database offline stores bound material knowledge points and bound material slices. The material slices are in at least two languages. The material knowledge points are in a standard language. The material knowledge points in the standard language are obtained from translation of material slices in a non-standard language. This solution offline stores material knowledge points in a standard language in the database, unifying the language of the to-be-answered query and the material knowledge points. This facilitates the retrieval of more knowledge points related to the to-be-answered query, thereby improving the accuracy of matching between the to-be-answered query and the material knowledge points. Additionally, the to-be-answered query is first matched with the offline-stored material knowledge points in the database at the character level and matched with the offline-stored material knowledge points in the database at the character level, screening out material knowledge points completely irrelevant to the to-be-answered query. This reduces the computational load during the answer generation process, enhances the speed of response of the large model to the to-be-answered query, and enables the retrieval of knowledge points most relevant to the to-be-answered query from the database.

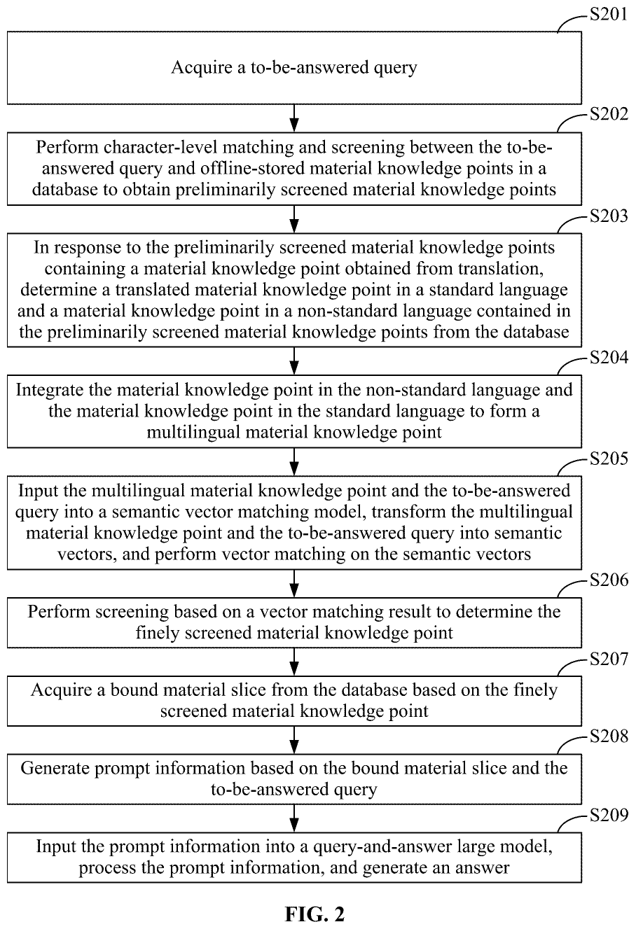

FIG. 2 is a flowchart of a retrieval-augmented query-and-answer method according to an embodiment of the present disclosure. This embodiment presents an optional solution based on the previous embodiment. This embodiment optimizes the operation of “semantic-level matching and screening is performed between the to-be-answered query and the preliminarily screened material knowledge points to obtain a finely screened material knowledge point”. It is to be noted that for what is not detailed in this embodiment of the present disclosure, see related description in other embodiments. Referring to FIG. 2, the retrieval-augmented query-and-answer method of this embodiment includes the following:

In S201, a to-be-answered query is acquired.

In S202, character-level matching and screening between the to-be-answered query and offline-stored material knowledge points in a database are performed to obtain preliminarily screened material knowledge points.

In S203, in response to the preliminarily screened material knowledge points containing a material knowledge point obtained from translation, a translated material knowledge point in a standard language and a material knowledge point in a non-standard language contained in the preliminarily screened material knowledge points from the database are determined.

The material knowledge points in non-standard languages refer to material knowledge points in languages that are not the standard language.

In one or more embodiments, when the preliminarily screened material knowledge points contains a material knowledge point obtained from translation, with the knowledge point identifier of the preliminarily screened material knowledge points as the index, a translated material knowledge point in a standard language and a material knowledge point contained in a non-standard language contained in the preliminarily screened material knowledge points are acquired from the database.

For example, when the standard language is Chinese, and the preliminarily screened material knowledge points A is a material knowledge point obtained from translation, and the knowledge point identifier of the preliminarily screened material knowledge points A is knowledge point identifier 1, then with knowledge point identifier 1 as the index, the material knowledge point in the non-standard language contained in the preliminarily screened material knowledge points A: “Lung organoids can be divided into airway and alveolar organoids [13-15]” and the translated material knowledge point in the standard language corresponding to the preliminarily screened material knowledge points A: original text in Chinese: “ [symbol] [symbol] [13-15]” (English translation: “Lung organoids can be divided into airway and alveolar organoids [13-15]”) are acquired from the database.

It is to be understood that when the preliminarily screened material knowledge points is a material knowledge point obtained from translation, the translated material knowledge point in the standard language and the material knowledge point in the non-standard language contained in the preliminarily screened material knowledge points are acquired from the database, encompassing different language expressions of the preliminarily screened material knowledge point, enhancing the comprehensiveness of the preliminarily screened material knowledge point, and facilitating subsequent crosslingual query-and-answer.

In S204, the material knowledge point in the non-standard language and the material knowledge point in the standard language are integrated to form a multilingual material knowledge point.

The multilingual material knowledge point refers to a knowledge point that encompasses multiple language expressions of the preliminarily screened material knowledge point.

In one or more embodiments, it is feasible to concatenate, in a certain concatenation sequence, the material knowledge point in the non-standard language contained in the preliminarily screened material knowledge points and the material knowledge point in the standard language corresponding to the preliminarily screened material knowledge points to obtain a multilingual material knowledge point. It is to be noted that the concatenation sequence is not limited in the embodiments of the present disclosure.

In an example, when the material knowledge point in the non-standard language corresponding to a preliminarily screened material knowledge point 1 is “Airway organoids originate from basal cells [8,16], which proliferate and differentiate to ciliated, goblet, and club cells in cyst-like structures.” and the material knowledge point in the standard language corresponding to the preliminarily screened material knowledge point 1 is original text in Chinese: “ [symbol] [8,16], [symbol] [symbol] [symbol] [symbol] ” (English translation: “Airway organoids originate from basal cells [8,16], which proliferate and differentiate to ciliated, goblet, and club cells in cyst-like structures”), it is feasible to concatenate the material knowledge point in the non-standard language first and the material knowledge point in the standard language second, thereby forming a multilingual material knowledge point corresponding to the preliminarily screened material knowledge point 1, that is, “Airway organoids originate from basal cells [8,16], which proliferate and differentiate to ciliated, goblet, and club cells in cyst-like structures. Original text in Chinese: [symbol] [symbol] [8,16], [symbol] [symbol] [symbol] [symbol] (English translation: “Airway organoids originate from basal cells [8,16], which proliferate and differentiate to ciliated, goblet, and club cells in cyst-like structures”).”.

It is to be understood that the integration of the material knowledge point in the non-standard language and the material knowledge point in the standard language effectively addresses the errors in grammar structure, word order, or semantics caused by inaccuracies in the translation model.

In S205, the multilingual material knowledge point and the to-be-answered query are inputted into a semantic vector matching model, the multilingual material knowledge point and the to-be-answered query are transformed into semantic vectors, and vector matching is performed on the semantic vectors.

Here the semantic vector matching model is an m-BERT model, and the semantic vector matching model is obtained by being trained using multilingual corpus samples.

In one or more embodiments, the multilingual material knowledge point and the to-be-answered query are inputted into the m-BERT model. The m-BERT model converts the multilingual material knowledge point into a multilingual material knowledge point vector and the to-be-answered query into a query vector and performs vector matching on the query vector and the multilingual material knowledge point vector. Since the multilingual material knowledge point includes different language expressions of the same knowledge point, the multilingual material knowledge point vector contains more semantic content, resulting in a more accurate matching result.

In S206, screening is performed based on a vector matching result to determine the finely screened material knowledge point.

In one or more embodiments, the multilingual material knowledge point whose vector matching result is successful is used as the finely screened material knowledge point.

In S207, a bound material slice is acquired from the database based on the finely screened material knowledge point.

In an optional embodiment, to better improve the retrieval accuracy of augmented retrieval, before acquiring the bound material slice from the database based on the finely screened material knowledge point, the method also includes inputting the finely screened material knowledge point and the to-be-answered query into a vector ranking model, transforming the finely screened material knowledge point and the to-be-answered query into semantic vectors, and ranking the semantic vectors based on similarity between the semantic vectors; and screening the finely screened material knowledge point based on a ranking result and a ranking screening condition.

The ranking screening condition may be preset according to actual service requirements or experimental experience. This is not limited by this disclosure.

In one or more embodiments, each finely screened material knowledge point and the to-be-answered query are inputted into the vector ranking model. The vector ranking model converts each finely screened material knowledge point into a first semantic vector and the to-be-answered query into a second semantic vector; calculates the similarity between the second semantic vector and each first semantic vector and ranks the finely screened material knowledge points based on similarity between the semantic vectors to obtain a ranking result; and removes finely screened material knowledge points that satisfy the ranking screening condition from the ranking result to obtain screened finely screened material knowledge points.

In S208, prompt information is generated based on the bound material slice and the to-be-answered query.

In S209, the prompt information is inputted into a query-and-answer large model and processed, and an answer is generated.

In this embodiment of the present disclosure, a to-be-answered query is acquired; character-level matching and screening between the to-be-answered query and offline-stored material knowledge points in a database are performed to obtain preliminarily screened material knowledge points; in response to the preliminarily screened material knowledge points containing a material knowledge point obtained from translation, a translated material knowledge point in a standard language and a material knowledge point in a non-standard language contained in the preliminarily screened material knowledge points from the database are determined; the material knowledge point in the non-standard language and the material knowledge point in the standard language are integrated to form multilingual material knowledge point; the multilingual material knowledge point and the to-be-answered query are inputted into a semantic vector matching model, the multilingual material knowledge point and the to-be-answered query are transformed into semantic vectors, and vector matching is performed on the semantic vectors; screening is performed based on a vector matching result to determine the finely screened material knowledge point; a bound material slice is acquired from the database based on the finely screened material knowledge point; prompt information is generated based on the bound material slice and the to-be-answered query; and the prompt information is inputted into a query-and-answer large model and processed, and an answer is generated. This solution integrates the material knowledge point in the non-standard language and the material knowledge point in the standard language to obtain a multilingual material knowledge point so that the database contains material knowledge points in different languages. This facilitates more accurate augmented retrieval based on the to-be-answered query, without the need to translate the to-be-answered query into different language expressions for enhanced retrieval, nor the need to form prompts in different languages, thereby improving the speed of response to the query-and-answer large model to the to-be-answered query. Additionally, character-level matching and screening between the to-be-answered query and the material knowledge points offline stored in the database before semantic-level matching and screening reduces the vector computational load in the answer generation process.

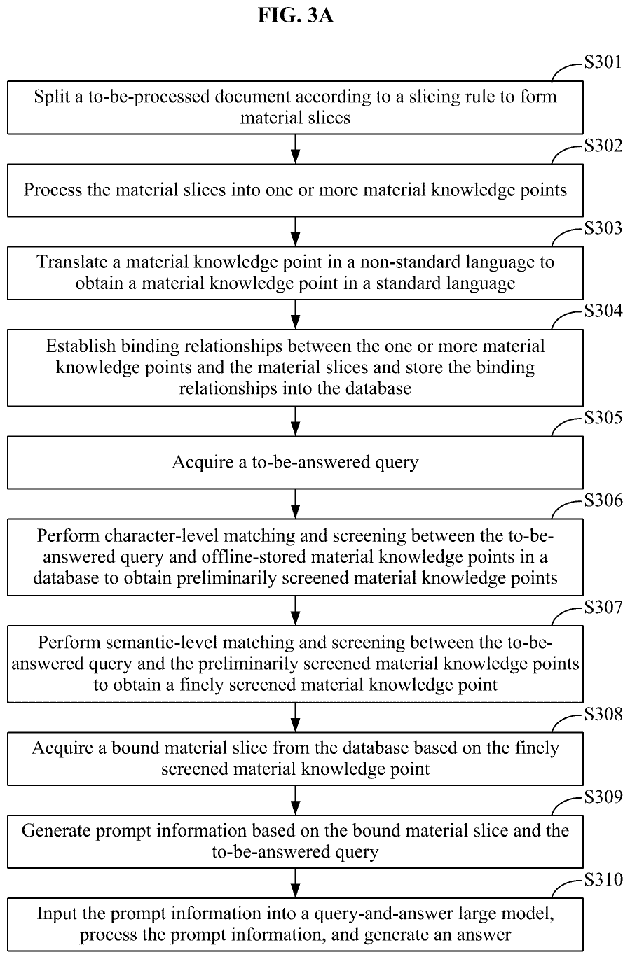

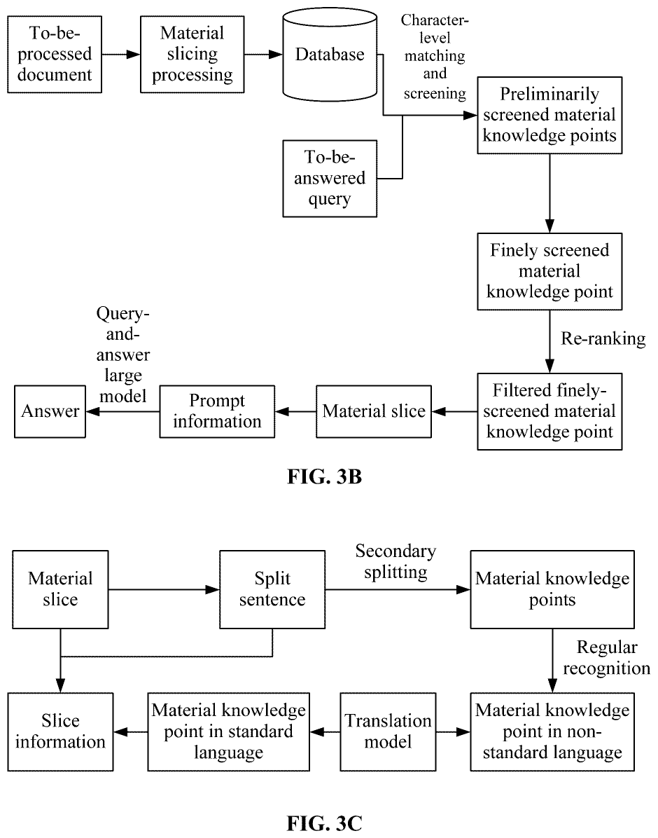

FIG. 3A is a flowchart of a retrieval-augmented query-and-answer method according to an embodiment of the present disclosure. This embodiment presents an optional solution based on the previous embodiments. In this embodiment, the offline generation process of the database is added. It is to be noted that for what is not detailed in this embodiment of the present disclosure, see related description in other embodiments. Referring to FIG. 3A, the retrieval-augmented query-and-answer method of this embodiment includes the following:

In S301, a to-be-processed document is split according to a slicing rule to form material slices.

The to-be-processed document refers to the document that needs to be processed. Optionally, the to-be-processed document may be, for example, an e-book, an online article, an academic paper, or a journal. The slicing rule refers to a rule used to split the to-be-processed document. Optionally, the slicing rule includes slicing setting information, for example, slice size, slice identifier, and slice order. It is to be noted that the slicing rule may be preset according to actual service requirements. For example, the slicing rule may be a sentence slicing rule, a paragraph slicing rule, or a chapter slicing rule. For another example, the slicing rule may be a recursive character text slicing rule. This is not limited by this embodiment of the present disclosure. The material slices refer to the slices into which the to-be-processed document is split.

In an example, the to-be-processed document is split according to the sentence slicing rule to obtain multiple material slices.

In an example, the to-be-processed document is split according to the paragraph slicing rule to obtain multiple material slices.

In an optional embodiment, before splitting the to-be-processed document according to the slicing rule to form the material slices, the method also includes recognizing the language of the to-be-processed document by using a set language recognition algorithm; and using the recognized language as the language of the material slices of the to-be-processed document.

The set language recognition algorithm includes at least one of the following: a language recognition model or a regular expression. The language recognition model is obtained by being trained using sample documents corresponding to the languages.

The language of the to-be-processed document is determined before the to-be-processed document is split, instead of determining the language of each material knowledge point after the to-be-processed document is split into material knowledge points. This accelerates the speed of translation of material knowledge points in non-standard languages into material knowledge points in the standard language.

In S302, the material slices are processed into one or more material knowledge points.

In one or more embodiments, when a material knowledge point is a semantically independent word, the material slices are processed into one or more material knowledge points by using a material slice model. The material slice model can be obtained by training a machine learning model by using sample material slices labeled with word tags.

In an optional embodiment, when a material knowledge point is a semantically independent sentence, the material slices are split into one or more sentences by using a sentence delimiter set in the standard language, and the split sentences are then further split based on at least one sentence splitting model in a non-standard language. The sentences obtained from secondary splitting are used as the material knowledge points.

The set sentence delimiter may be preset according to actual service requirements. The set sentence delimiter may be, for example, a period, a comma, a semicolon, an exclamation mark, or a question mark. The at least one sentence splitting model may be preset according to actual service requirements. For example, the at least one sentence splitting model may be a Natural Language Toolkit (NLTK) model. The NLTK model can be obtained by being trained using sample sentences corresponding to non-standard languages.

In one or more embodiments, when a material knowledge point is a semantically independent sentence, the material slices are split into one or more split sentences by using a set sentence delimiter in the standard language. The non-standard languages involved in the split sentences are determined. Secondary splitting is performed on the split sentences by using different sentence splitting models in non-standard languages. Thus secondary split sentences, that is, the material knowledge points, are obtained. when the language of the split sentences is the standard language, the split sentences are used as the material knowledge points.

In an example, when the standard language is Chinese, and the non-standard languages involved in the split sentences include English, Japanese, and French, then an English sentence splitting model, a Japanese sentence splitting model, and a French sentence splitting model are used to perform secondary splitting on the split sentences, thus obtaining the secondary split sentences, that is, the material knowledge points.

Secondary splitting is performed on the split sentences by using the sentence splitting model in the non-standard language after the material slices are split using the set sentence delimiter in the standard language, avoiding incorrect splitting of sentences or words in non-standard languages in the material slices, thereby ensuring the semantic integrity and accuracy of the material knowledge points.

In S303, a material knowledge point in a non-standard language is translated to obtain a material knowledge point in a standard language.

In one or more embodiments, the material knowledge points in non-standard languages are translated using a multilingual translation model, thereby obtaining the material knowledge points in the standard language. The multilingual translation model is obtained by training a machine learning model by using sample material knowledge points in different languages.

In an optional embodiment, the material knowledge points in non-standard languages are translated using translation models corresponding to their respective languages to obtain the material knowledge points in the standard language. The translation model corresponding to each language is obtained by being trained using language-specific samples. The language-specific samples consist of character and word samples.

In one or more embodiments, the target language of the material knowledge points in non-standard languages are recognized using a language recognition model. The material knowledge points in non-standard languages are then translated using the translation model corresponding to the target language to obtain the material knowledge points in the standard language.

Compared with the solution of translating material knowledge points in non-standard languages into material knowledge points in the standard language by using a general multilingual translation model, the solution of translating material knowledge points in non-standard languages into material knowledge points in the standard language by using language-specific translation models improves the translation accuracy while reducing the scale requirements of the translation model. Since character-level preliminary matching and screening is conducted before semantic-level fine matching and screening during online query-and-answer generation, the translation accuracy requirements for material knowledge points in the database are not high. For example, grammar structures are not highly precise. Therefore, the translation model can be trained using only word-level samples without requiring a large number of sentence-level or even document-level samples. This significantly reduces the costs of the translation model.

In an optional embodiment, it is feasible to, before the material knowledge point in the non-standard language is translated, recognize languages of the material knowledge points by using the regular expression.

In one or more embodiments, for each material knowledge point, it is feasible to identify the special character set in the material knowledge point by using the regular expression and determine the language of the material knowledge point based on the special character set. For example, when a material knowledge point does not contain any Chinese character, this material knowledge point is considered a material knowledge point in a non-standard language.

In an optional embodiment, for each material knowledge point, it is feasible to identify the specific syntax structure (or specific vocabulary) in the material knowledge point by using the regular expression and determine the language of the material knowledge point based on the specific syntax structure (or specific vocabulary).

In an optional embodiment, for each material knowledge point, it is feasible to identify the special character set and the specific syntax structure (or specific vocabulary) in the material knowledge point by using the regular expression and determine the language of the material knowledge point based on the special character set and the specific syntax structure (or specific vocabulary).

It is to be understood that before translating the material knowledge point in the non-standard language, it is feasible to first determine the language of each material knowledge point by using the regular expression so as to select the material knowledge point in the non-standard language. This allows translation to be performed on only the material knowledge point in the non-standard language, reducing unnecessary translation and accelerating the translation speed of the material knowledge point in the non-standard language.

In S304, binding relationships between the one or more material knowledge points and the material slices are established and stored into the database.

In one or more embodiments, it is feasible to establish the binding relationships between the material knowledge points and the material slices by creating an association table and storing the association table into the database.

In S305, a to-be-answered query is acquired.

In S306, character-level matching and screening between the to-be-answered query and offline-stored material knowledge points in a database are performed to obtain preliminarily screened material knowledge points.

In S307, semantic-level matching and screening is performed between the to-be-answered query and the preliminarily screened material knowledge points to obtain a finely screened material knowledge point.

In S308, a bound material slice is acquired from the database based on the finely screened material knowledge point.

In S309, prompt information is generated based on the bound material slice and the to-be-answered query.

In S310, the prompt information is inputted into a query-and-answer large model and processed, and an answer is generated.

The database offline stores bound material knowledge points and bound material slices. The material slices are in at least two languages. The material knowledge points are in a standard language. The material knowledge points in the standard language are obtained from translation of material slices in a non-standard language.

In this embodiment of the present disclosure, a to-be-processed document is split according to a slicing rule to form material slices; the material slices are processed into one or more material knowledge points; a material knowledge point in a non-standard language is translated to obtain a material knowledge point in a standard language; binding relationships between the one or more material knowledge points and the material slices are established and stored into the database; a to-be-answered query is acquired; character-level matching and screening between the to-be-answered query and offline-stored material knowledge points in a database are performed to obtain preliminarily screened material knowledge points; semantic-level matching and screening is performed between the to-be-answered query and the preliminarily screened material knowledge points to obtain a finely screened material knowledge point; a bound material slice is acquired from the database based on the finely screened material knowledge point; prompt information is generated based on the bound material slice and the to-be-answered query; and the prompt information is inputted into a query-and-answer large model and processed, and an answer is generated. This solution enables offline processing of documents in different languages. Material knowledge points in non-standard languages are pre-converted into material knowledge points in the standard language. The binding relationships between the material knowledge points and the material slices are established and stored in the database. This unifies the language of the to-be-answered query and the material knowledge points and facilitates the retrieval of more knowledge points related to the to-be-answered query, thereby improving the accuracy of matching between the to-be-answered query and the material knowledge points.

This embodiment of the present disclosure provides a retrieval-augmented query-and-answer process as shown in FIG. 3B. This process mainly consists of two stages: the offline database preparation stage and the online query-and-answer stage. The offline database preparation stage includes slicing the to-be-processed document, processing the material slices as shown in FIG. 3C, forming material knowledge points in the standard language, storing the material knowledge points in the standard language in the database, and establishing the relationships between the material knowledge points and the material slices. The online query-and-answer stage includes acquiring the to-be-answered query proposed by a user; performing character-level matching between the to-be-answered query and the material knowledge points in the database to obtain preliminarily screened material knowledge points; conducting hybrid retrieval on the preliminarily screened material knowledge points to obtain finely screened material knowledge points, where the hybrid retrieval may include, but is not limited to, vector retrieval and the best match algorithm BM25; re-ranking the finely screened material knowledge points to obtain the ranked screened finely screened material knowledge points; obtaining the bound material slices based on the finely screened material knowledge points; generating prompt information based on the bound material slice and the to-be-answered query; and inputting the prompt information into the query-and-answer large model to generate the answer. Referring to FIG. 3C, after splitting the document into material slices, it is feasible to process the material slices into sentences, identify non-Chinese sentences by using a regular expression algorithm, translate the non-Chinese sentences by using a translation model to obtain Chinese sentences, and store both the Chinese sentences obtained from the material slices and the translated Chinese sentences as material knowledge points in the standard language and slice information into the database.

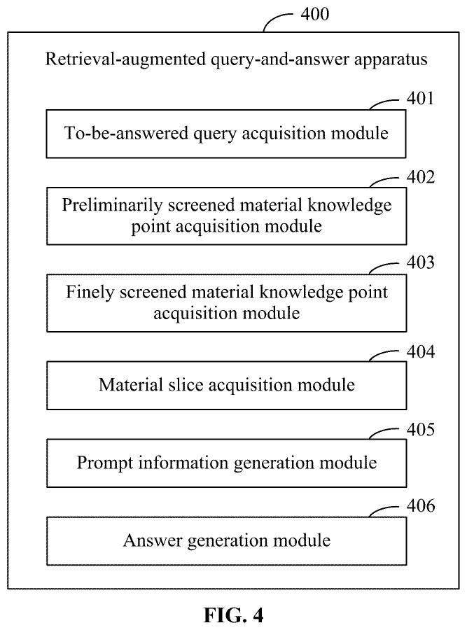

FIG. 4 is a block diagram of a retrieval-augmented query-and-answer apparatus according to an embodiment of the present disclosure. This embodiment of the present disclosure is applicable to a scenario of crosslingual query-and-answer based on a large model. This apparatus may be implemented by software and/or hardware and may be configured in an electronic device. Referring to FIG. 4, the retrieval-augmented query-and-answer apparatus 400 includes a to-be-answered query acquisition module 401, preliminarily screened material knowledge point acquisition module 402, a finely screened material knowledge point acquisition module 403, a material slice acquisition module 404, a prompt information generation module 405, and an answer generation module 406.

The to-be-answered query acquisition module 401 is configured to acquire a to-be-answered query.

The preliminarily screened material knowledge point acquisition module 402 is configured to perform character-level matching and screening between the to-be-answered query and offline-stored material knowledge points in a database to obtain preliminarily screened material knowledge points.

The finely screened material knowledge point acquisition module 403 is configured to perform semantic-level matching and screening between the to-be-answered query and the preliminarily screened material knowledge points to obtain a finely screened material knowledge point.

The material slice acquisition module 404 is configured to acquire a bound material slice from the database based on the finely screened material knowledge point.

The prompt information generation module 405 is configured to generate prompt information based on the bound material slice and the to-be-answered query.

The answer generation module 406 is configured to input the prompt information into a query-and-answer large model, process the prompt information, and generate an answer.

The database offline stores bound material knowledge points and bound material slices. The material slices are in at least two languages. The material knowledge points are in a standard language. The material knowledge points in the standard language are obtained from translation of material slices in a non-standard language.

The solution of this embodiment of the present disclosure includes acquiring a to-be-answered query; performing character-level matching and screening between the to-be-answered query and offline-stored material knowledge points in a database to obtain preliminarily screened material knowledge points; performing semantic-level matching and screening between the to-be-answered query and the preliminarily screened material knowledge points to obtain a finely screened material knowledge point; acquiring a bound material slice from the database based on the finely screened material knowledge point; generating prompt information based on the bound material slice and the to-be-answered query; and inputting the prompt information into a query-and-answer large model, processing the prompt information, and generating an answer. The database offline stores bound material knowledge points and bound material slices. The material slices are in at least two languages. The material knowledge points are in a standard language. The material knowledge points in the standard language are obtained from translation of material slices in a non-standard language. This solution offline stores material knowledge points in a standard language in the database, unifying the language of the to-be-answered query and the material knowledge points. This facilitates the retrieval of more knowledge points related to the to-be-answered query, thereby improving the accuracy of matching between the to-be-answered query and the material knowledge points. Additionally, the to-be-answered query is first matched with the offline-stored material knowledge points in the database at the character level and matched with the offline-stored material knowledge points in the database at the character level, screening out material knowledge points completely irrelevant to the to-be-answered query. This reduces the computational load during the answer generation process, enhances the speed of response of the large model to the to-be-answered query, and enables the retrieval of knowledge points most relevant to the to-be-answered query from the database.

In an optional embodiment, the finely screened material knowledge point acquisition module 403 is configured to in response to the preliminarily screened material knowledge points containing a material knowledge point obtained from translation, determine a translated material knowledge point in a standard language and a material knowledge point in a non-standard language contained in the preliminarily screened material knowledge points from the database; integrate the material knowledge point in the non-standard language with the material knowledge point in the standard language to form a multilingual material knowledge point; input the multilingual material knowledge point and the to-be-answered query into a semantic vector matching model, transform the multilingual material knowledge point and the to-be-answered query into semantic vectors, and perform vector matching on the semantic vectors; and perform screening based on a vector matching result to determine the finely screened material knowledge point.

In an optional embodiment, the semantic vector matching model is an m-BERT model, and the semantic vector matching model is obtained by being trained using multilingual corpus samples.

In an optional embodiment, the retrieval-augmented query-and-answer apparatus 400 also includes a vector ranking module and a finely screened material knowledge point screening module.

The vector ranking module is configured to, before the bound material slice is acquired from the database based on the finely screened material knowledge point, input the finely screened material knowledge point and the to-be-answered query into a vector ranking model, transform the finely screened material knowledge point and the to-be-answered query into semantic vectors, and rank the semantic vectors based on similarity between the semantic vectors.

The finely screened material knowledge point screening module is configured to filter the finely screened material knowledge point based on a ranking result and a ranking screening condition.

In an optional embodiment, the prompt information generation module 405 is configured to acquire a prompt information template, add the material slice to a material area of the prompt information template, add the to-be-answered query to a query area of the prompt information template, and generate the prompt information.

In an optional embodiment, the retrieval-augmented query-and-answer apparatus 400 also includes a database offline generation module. The database offline generation module includes a material slice formation unit, a material slice processing unit, a material knowledge point translation unit, and a binding relationship establishment unit.

The material slice formation unit is configured to split a to-be-processed document according to a slicing rule to form material slices.

The material slice processing unit is configured to process the material slices into one or more material knowledge points.

The material knowledge point translation unit is configured to translate the material knowledge point in the non-standard language to obtain the material knowledge point in the standard language.

The binding relationship establishment unit is configured to establish binding relationships between the one or more material knowledge points and the material slices and store the binding relationships into the database.

In an optional embodiment, the material knowledge points are independent semantic sentences, and the material slice processing unit is configured to split the material slices by using a set sentence delimiter in a standard language to obtain one or more sentences; and perform secondary splitting of the split sentences based on a sentence splitting model in at least one non-standard language and use sentences obtained from the secondary splitting as material knowledge points.

In an optional embodiment, the database offline generation module also includes a material knowledge point language determination unit.

The material knowledge point language determination unit is configured to, before the material knowledge point in the non-standard language is translated, recognize languages of the one or more material knowledge points by using a regular expression.

In an optional embodiment, the material knowledge point translation unit is configured to translate the material knowledge point in the non-standard language through a translation model corresponding to the non-standard language to obtain the material knowledge point in the standard language.

The translation model corresponding to the non-standard language is obtained by being trained using samples corresponding to the non-standard language. The samples corresponding to the non-standard language are word samples.

In an optional embodiment, the database offline generation module also includes a document language recognition unit.

The document language recognition unit is configured to, before the to-be-processed document is split according to the slicing rule to form the material slices, recognize the language of the to-be-processed document by using a set language recognition algorithm and use the recognized language as the language of the material slices of the to-be-processed document.

In an optional embodiment, the set language recognition algorithm includes at least one of the following: a language recognition model or a regular expression.

The retrieval-augmented query-and-answer apparatus of this embodiment of the present disclosure can perform the retrieval-augmented query-and-answer method of any embodiment of the present disclosure and has function modules and beneficial effects corresponding to the performed retrieval-augmented query-and-answer method.

In the technical solutions of the present disclosure, the collection, storage, use, processing, transmission, provision and disclosure of user personal information involved are in compliance with provisions of relevant laws and regulations and do not violate public order and good customs.

According to embodiments of the present disclosure, the present disclosure further provides an electronic device, a readable storage medium, and a computer program product.

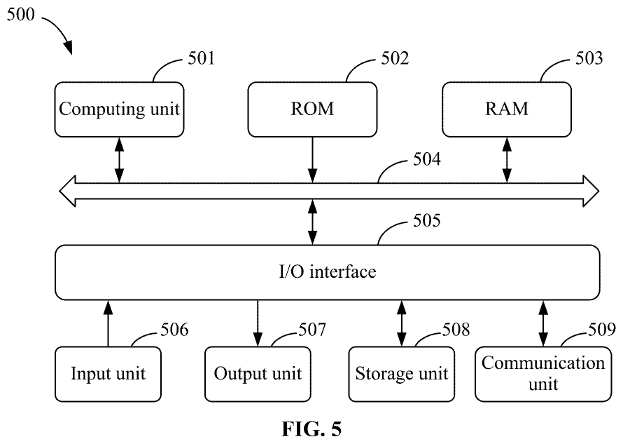

FIG. 5 is a block diagram of an example electronic device 500 that can implement an embodiment of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device, and a similar computing apparatus. Herein the shown components, the connections and relationships between these components, and the functions of these components are illustrative and are not intended to limit the implementation of the present disclosure as described and/or claimed herein.

As shown in FIG. 5, the device 500 includes a computing unit 501. The computing unit 501 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 503. The computing unit 501, the ROM 502, and the RAM 503 are connected to each other through a bus 504. An input/output (I/O) interface 505 is also connected to the bus 504.

Multiple components in the device 500 are connected to the I/O interface 505. The components include an input unit 506 such as a keyboard and a mouse, an output unit 507 such as various types of displays and speakers, the storage unit 508 such as a magnetic disk and an optical disc, and a communication unit 509 such as a network card, a modem and a wireless communication transceiver. The communication unit 509 allows the device 500 to exchange information/data with other devices over a computer network such as the Internet and/or various telecommunications networks.

The computing unit 501 may be various general-purpose and/or special-purpose processing components having processing and computing capabilities. Examples of the computing unit 501 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and microcontroller. The computing unit 501 performs various preceding methods and processing, such as the retrieval-augmented query-and-answer method. For example, in some embodiments, the retrieval-augmented query-and-answer method may be implemented as computer software programs tangibly contained in a machine-readable medium such as the storage unit 508. In some embodiments, part or all of computer programs may be loaded and/or installed on the device 500 via the ROM 502 and/or the communication unit 509. When the computer program is loaded to the RAM 503 and executed by the computing unit 501, one or more steps of the preceding retrieval-augmented query-and-answer method may be performed. Alternatively, in other embodiments, the computing unit 501 may be configured, in any other appropriate manner (for example, by means of firmware), to perform the retrieval-augmented query-and-answer method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in a flowchart and/or a block diagram to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device or any appropriate combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network and the Internet.

A computer system may include clients and servers. A client and a server are generally remote from each other and typically interact through a communication network. The relationship between the clients and the servers arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is a discipline studying the simulation of certain human thinking processes and intelligent behaviors (such as learning, reasoning, thinking and planning) by a computer and involves techniques at both hardware and software levels. Hardware techniques of artificial intelligence generally include techniques such as sensors, special-purpose artificial intelligence chips, cloud computing, distributed storage and big data processing. Software techniques of artificial intelligence mainly include several major directions such as computer vision technology, speech recognition technology, natural language processing technology, machine learning/deep learning technology, big data processing technology and knowledge graph technology.

Cloud computing refers to a technical system that accesses a shared elastic-and-scalable physical or virtual resource pool through a network and can deploy and manage resources in an on-demand self-service manner, where the resources may include servers, operating systems, networks, software, applications, storage devices and the like. Cloud computing can provide efficient and powerful data processing capabilities for model training and technical applications such as artificial intelligence and blockchain.

It is to be understood that various forms of the preceding flows may be used with steps reordered, added or removed. For example, the steps described in the present disclosure may be executed in parallel, in sequence, or in a different order as long as the desired result of the technical solutions provided in the present disclosure is achieved. The execution sequence of these steps is not limited herein.

The scope of the present disclosure is not limited by the preceding embodiments. It is to be understood by those skilled in the art that various modifications, combinations, sub-combinations and substitutions may be made according to design requirements and other factors. Any modification, equivalent substitution and improvement made within the principle of the present disclosure is within the scope of the present disclosure.

What is claimed is:

1. A retrieval-augmented query-and-answer method, comprising:
acquiring a to-be-answered query;
performing character-level matching and screening between the to-be-answered query and offline-stored material knowledge points in a database to obtain preliminarily screened material knowledge points;
performing semantic-level matching and screening between the to-be-answered query and the preliminarily screened material knowledge points to obtain a finely screened material knowledge point;
acquiring a bound material slice from the database based on the finely screened material knowledge point;
generating prompt information based on the bound material slice and the to-be-answered query; and
inputting the prompt information into a query-and-answer large model, processing the prompt information, and generating an answer,
wherein the database offline stores bound material knowledge points and bound material slices, the material slices are in at least two languages, the material knowledge points are in a standard language, and the material knowledge points in the standard language are obtained from translation of material slices in a non-standard language.

2. The method of claim 1, wherein performing the semantic-level matching and screening between the to-be-answered query and the preliminarily screened material knowledge points to obtain the finely screened material knowledge point comprises:
in response to the preliminarily screened material knowledge points containing a material knowledge point obtained from translation, determining a translated material knowledge point in a standard language and a material knowledge point in a non-standard language contained in the preliminarily screened material knowledge points from the database;
integrating the material knowledge point in the non-standard language with the material knowledge point in the standard language to form a multilingual material knowledge point;
inputting the multilingual material knowledge point and the to-be-answered query into a semantic vector matching model, transforming the multilingual material knowledge point and the to-be-answered query into semantic vectors, and performing vector matching on the semantic vectors; and
performing screening based on a vector matching result to determine the finely screened material knowledge point.

3. The method of claim 2, wherein the semantic vector matching model is an m-BERT model, and the semantic vector matching model is obtained by being trained using multilingual corpus samples.

4. The method of claim 1, wherein before acquiring the bound material slice from the database based on the finely screened material knowledge point, the method further comprises:
inputting the finely screened material knowledge point and the to-be-answered query into a vector ranking model, transforming the finely screened material knowledge point and the to-be-answered query into semantic vectors, and ranking the semantic vectors based on similarity between the semantic vectors; and
screening the finely screened material knowledge point based on a ranking result and a ranking screening condition.

5. The method of claim 1, wherein generating the prompt information based on the bound material slice and the to-be-answered query comprises:
acquiring a prompt information template, adding the material slice to a material area of the prompt information template, adding the to-be-answered query to a query area of the prompt information template, and generating the prompt information.

6. The method of claim 1, wherein an offline generation process of the database comprises:
splitting a to-be-processed document according to a slicing rule to form material slices;
processing the material slices into one or more material knowledge points;
translating a material knowledge point in a non-standard language among the one or more material knowledge points to obtain a material knowledge point in a standard language; and
establishing binding relationships between the one or more material knowledge points and the material slices and storing the binding relationships into the database.

7. The method of claim 6, wherein the one or more material knowledge points are independent semantic sentences, and processing the material slices into the one or more material knowledge points comprises:
splitting the material slices by using a set sentence delimiter in a standard language to obtain one or more sentences; and
performing secondary splitting of the split sentences based on a sentence splitting model in at least one non-standard language, and using sentences obtained from the secondary splitting as material knowledge points.

8. The method of claim 6, wherein before translating the material knowledge point in the non-standard language, the method further comprises:
recognizing languages of the one or more material knowledge points by using a regular expression.

9. The method of claim 6, wherein translating the material knowledge point in the non-standard language among the one or more material knowledge points to obtain the material knowledge point in the standard language comprises:
translating the material knowledge point in the non-standard language through a translation model corresponding to the non-standard language to obtain the material knowledge point in the standard language, wherein
the translation model corresponding to the non-standard language is obtained by being trained using samples corresponding to the non-standard language, wherein the samples corresponding to the non-standard language are word samples.

10. The method of claim 6, wherein before splitting the to-be-processed document according to the slicing rule to form the material slices, the method further comprises:
recognizing a language of the to-be-processed document by using a set language recognition algorithm; and using the recognized language as a language of the material slices of the to-be-processed document.

11. The method of claim 10, wherein the set language recognition algorithm comprises at least one of the following: a language recognition model or a regular expression.

12. An electronic device, comprising:
at least one processor; and
a memory communicatively connected to the at least one processor,
wherein the memory stores instructions executable by the at least one processor to enable the at least one processor to perform:
acquiring a to-be-answered query;
performing character-level matching and screening between the to-be-answered query and offline-stored material knowledge points in a database to obtain preliminarily screened material knowledge points;
performing semantic-level matching and screening between the to-be-answered query and the preliminarily screened material knowledge points to obtain a finely screened material knowledge point;
acquiring a bound material slice from the database based on the finely screened material knowledge point;
generating prompt information based on the bound material slice and the to-be-answered query; and
inputting the prompt information into a query-and-answer large model, processing the prompt information, and generating an answer,
wherein the database offline stores bound material knowledge points and bound material slices, the material slices are in at least two languages, the material knowledge points are in a standard language, and the material knowledge points in the standard language are obtained from translation of material slices in a non-standard language.

13. The electronic device of claim 12, wherein performing the semantic-level matching and screening between the to-be-answered query and the preliminarily screened material knowledge points to obtain the finely screened material knowledge point comprises:
in response to the preliminarily screened material knowledge points containing a material knowledge point obtained from translation, determining a translated material knowledge point in a standard language and a material knowledge point in a non-standard language contained in the preliminarily screened material knowledge points from the database;
integrating the material knowledge point in the non-standard language with the material knowledge point in the standard language to form a multilingual material knowledge point;
inputting the multilingual material knowledge point and the to-be-answered query into a semantic vector matching model, transforming the multilingual material knowledge point and the to-be-answered query into semantic vectors, and performing vector matching on the semantic vectors; and
performing screening based on a vector matching result to determine the finely screened material knowledge point.

14. The electronic device of claim 13, wherein the semantic vector matching model is an m-BERT model, and the semantic vector matching model is obtained by being trained using multilingual corpus samples.

15. The electronic device of claim 12, wherein before acquiring the bound material slice from the database based on the finely screened material knowledge point, the memory stores instructions executable by the at least one processor to enable the at least one processor to perform:
inputting the finely screened material knowledge point and the to-be-answered query into a vector ranking model, transforming the finely screened material knowledge point and the to-be-answered query into semantic vectors, and ranking the semantic vectors based on similarity between the semantic vectors; and
screening the finely screened material knowledge point based on a ranking result and a ranking screening condition.

16. The electronic device of claim 12, wherein generating the prompt information based on the bound material slice and the to-be-answered query comprises:
acquiring a prompt information template, adding the material slice to a material area of the prompt information template, adding the to-be-answered query to a query area of the prompt information template, and generating the prompt information.

17. The electronic device of claim 12, wherein an offline generation process of the database comprises:
splitting a to-be-processed document according to a slicing rule to form material slices;
processing the material slices into one or more material knowledge points;
translating a material knowledge point in a non-standard language among the one or more material knowledge points to obtain a material knowledge point in a standard language; and
establishing binding relationships between the one or more material knowledge points and the material slices and storing the binding relationships into the database.

18. The electronic device of claim 17, wherein the one or more material knowledge points are independent semantic sentences, and processing the material slices into the one or more material knowledge points comprises:
splitting the material slices by using a set sentence delimiter in a standard language to obtain one or more sentences; and
performing secondary splitting of the split sentences based on a sentence splitting model in at least one non-standard language, and using sentences obtained from the secondary splitting as material knowledge points.

19. The electronic device of claim 17, wherein before translating the material knowledge point in the non-standard language, the memory stores instructions executable by the at least one processor to enable the at least one processor to perform:
recognizing languages of the one or more material knowledge points by using a regular expression.

20. A non-transitory computer-readable storage medium storing computer instructions for causing a computer to perform:
acquiring a to-be-answered query;
performing character-level matching and screening between the to-be-answered query and offline-stored material knowledge points in a database to obtain preliminarily screened material knowledge points;
performing semantic-level matching and screening between the to-be-answered query and the preliminarily screened material knowledge points to obtain a finely screened material knowledge point;
acquiring a bound material slice from the database based on the finely screened material knowledge point;
generating prompt information based on the bound material slice and the to-be-answered query; and
inputting the prompt information into a query-and-answer large model, processing the prompt information, and generating an answer,
wherein the database offline stores bound material knowledge points and bound material slices, the material slices are in at least two languages, the material knowledge points are in a standard language, and the material knowledge points in the standard language are obtained from translation of material slices in a non-standard language.
